(19) United States
(12) Patent Application Publication
(10) Pub. No.: US 2026/0220360 A1
(43) Pub. Date: Jul. 30, 2026

(54) WRITTEN PAPER CONCEPT DEVELOPMENT AID, RESEARCH DATA ORGANIZER, AND COMPOSITION ASSISTANT

(71) Applicant: Michael Ross Lanier, Walnut Springs, TX (US)

(72) Inventor: Michael Ross Lanier, Walnut Springs, TX (US)

(21) Appl. No.: 19/181,130

(22) Filed: Apr. 16, 2025

Related U.S. Application Data
(60) Provisional application No. 63/634,720, filed on Apr. 16, 2024.

(51) Int. Cl. G06F 40/169; G06F 40/106; G06F 40/197

(52) U.S. Cl. CPC G06F 40/169; G06F 40/106; G06F 40/197

(57) ABSTRACT

A computer-implemented process and software interface components that assist an author in authoring structured papers academic or professional papers by providing discrete work areas for the gathering of materials (e.g., notes, bibliographic references, quotations), and the creation, organization, evolution, refinement, and harmonization of its foundation components (i.e., its title, topic statement, abstract, thesis, outline, discussion structure, texts, and citations). The invention automates the processes heretofore managed by index cards, sticky notes, and 3-hole punched paper, offering multiple and distinct timesaving and safekeeping advantages over analog storage and organizational means and methods. The invention allows for the possibility that an author's access to resources may not follow an ideal order for gathering data (e.g., work hours/family responsibilities that conflict with library hours). This convenience stems from the input data types being grouped into several grids rather than in the form of the final paper.

### CROSS-REFERENCES TO RELATED APPLICATIONS

This application relates to the Utility-Provisional Application 63/634,720, “Written Paper Concept Development Aid, Research Data Organizer, and Composition Assistant”, timestamped Apr. 16, 2024 04:19:55 PM Z ET, as its formal application.

### FIELD

The present invention relates to computer-implemented systems and methods for assisting authors in the concept, organization, structure, and content development of academic or professional papers. Specifically, the invention provides a concept development module, multi-column grid interface, and export functionality for managing notes, outlines, thesis statements, abstracts, and supporting references, whether or not the author chooses to utilize built-in artificial intelligence tools.

### BACKGROUND

Authors have long utilized analog tools such as index cards, binders, and sticky notes to plan and organize written works. Over time, digital tools like word processors and citation generators have replaced or supplemented these methods. However, existing systems lack comprehensive tools that support foundational steps of paper writing—such as topic refinement, argument structure, integration of research materials, and progress tracking—especially in early stages before drafting begins.

This invention addresses that unmet need with a computer-implemented authoring system that includes dedicated modules for concept development, data organization, research integration, and real-time export. It optionally uses AI to assist but is designed to function fully without AI intervention.

Tools—such as index cards and boxes; pens, pencils, erasers, and highlighters; three-ringed binders; ruled binder filler paper; tabbed dividers; file folders; and accordion file organizers. These tools would help authors by not only providing places for their evolving notes and collected citations, but the means for organizing and reordering their material as it grew or as their research discoveries required them to make changes.

Reference materials—such as dictionaries, thesauruses, manuals of style, grammar usage books, encyclopedias, and critical thinking guides. These enhanced the overall quality and integrity of finished papers.

Resources—such as libraries, museums, and art galleries,

Methods—such as Bloom's Taxonomy, argumentative essay structures (Toulmin, Rogerian, Aristotelian), and non-argumentative essay structures. These methods provide authors a pattern to follow as they develop their papers, freeing them from having to come up with a paper's structure every time they write.

At present, many of the tools and resources mentioned have been computerized. Word processor applications were among the first to be implemented on personal computers, and they continue to offer more powerful features with each release. Following the creation of word processors were the implementation of electronic dictionaries and thesauruses, and later grammar/punctuation checkers, available both online and as features incorporated into word processing packages. More recently, the most specialized of the resources have appeared: bibliographic citation generators, again available both online and at least partially integrated into word processing applications.

For all the features that word processing, grammar/spelling/punctuation checking, and bibliographic applications have to offer, it seems that no one has implemented tools that aid the author with paper-writing fundamentals—concept development, organization (both initial and ongoing), and synthesis of citations into an author's own thoughts—all of which should be established prior to the actual writing phase, to avoid time-consuming and emotionally taxing revisions.

This unmet need has driven this invention into existence. Computerized toolboxes, work areas, and wizards lend themselves well to completing tasks that require having all relevant resources at hand to accelerate each task's processes.

### SUMMARY

The invention comprises a software-based authoring environment that assists an author through all stages of writing, including:
Concept development via a structured wizard interface (the “concept development module”)
A multi-column grid interface showing outline structure, associated notes, and paragraph drafts
Dynamic handling of hierarchical decimal identifiers for organizing outline entries
A paragraph builder for constructing well-formed paragraphs linked to outline sections
Integrated citation management tools
Export capabilities to generate word processing documents compliant with academic formatting
Tools for placing reminders and reviewing prior versions

The system provides responsive user interface behavior, including dynamically appearing tools, cursor-triggered controls, and AI-assisted suggestions—if the user opts in.

### BRIEF DESCRIPTION OF THE DRAWINGS

FIG. 1 is a screenshot of the Outline Worksheet, showing a column for hierarchical decimal identifiers and an adjacent column for outline entries.

FIGS. 2 through 10 depict the Concept Development Module's multi-step wizard interface, including tools for topic selection, thesis generation, outline construction, and abstract writing.

FIG. 11 shows the version history interface, allowing users to navigate and restore prior content states.

FIG. 12 displays the Notes Worksheet, allowing users to input research notes and associate them with specific outline headings.

FIG. 13 illustrates the Link to Outline tool, which connects individual notes to hierarchical entries.

FIG. 14 shows the Find Anything Anywhere tool, a search module with wildcard support across the paper's content.

FIGS. 15 and 16 depict the Toolbox interface, showing general tool access and submenu views.

FIG. 17 shows the Reminders tool, with options for setting and managing in-line reminders.

FIG. 18 illustrates the optional AI interface tool, which can provide curated responses, topic suggestions, or paragraph development support.

FIG. 19 presents the Paragraph Builder interface, including fields for topic sentence, supporting sentence(s), and concluding/transition sentence, with preview and citation options.

FIG. 20 shows the Sources Manager, where users manage bibliographic references linked to external citation tools.

FIG. 21 displays the Add/Remove Citation tool for placing and managing citations in the body text.

FIGS. 22 through 25 demonstrate the Export to Word interface, with views for metadata entry, title/heading customization, oral committee formatting, and layout selection.

FIGS. 26 through 28 reference external tools provided by Zotero, used in conjunction with the Sources Manager for citation handling.

### DETAILED DESCRIPTION

The invention enables an author to begin with a topic and proceed through a structured, flexible framework that guides paper creation from concept to final formatting. The core elements are as follows:

Concept Development Module—This wizard-based tool presents five steps, helping the user define a paper topic, refine scope, choose tone, generate a thesis, produce an abstract, and outline the discussion structure. Each step offers AI-assisted suggestions (optional) and integrates with subsequent components in the system.

Multi-Column Grid Interface—The invention's layout includes a grid with visible alignment between outline headings, linked notes, and drafted content. This view allows for real-time editing and progress tracking.

Outline Worksheet—A dedicated workspace for managing hierarchical structure, using automatically calculated decimal identifiers (e.g., 1, 1.1, 1.1.1) that adjust dynamically as content is added, removed, or reorganized.

Notes Worksheet—Captures freeform notes from lectures, readings, and research. Notes may be tagged or linked to outline headings and reviewed later in context with draft paragraphs.

Paragraph Builder—Constructs coherent paragraphs based on selected outline entries and associated notes. Users may fill fields for topic sentences, supporting content, and concluding transitions. Built-in citation support is also provided.

Citation Management—Through integration with tools like Zotero, the invention allows users to search, insert, and format citations within the document. Users can specify citation style, placement (in-text, footnotes, endnotes), and manage a full bibliography.

Reminders and Version History—Users can place reminders at any section in the paper for future editing tasks. A separate version control system stores prior edits and allows for selective content recovery.

Export Module—The invention supports exporting content at any stage into formatted academic papers, including MLA, APA, Chicago, and custom formats. Export options allow toggling inclusion of outlines, citations, and author notes.

Offline Functionality—Core functions such as the grid interface, note linking, paragraph building, and outline organization work without Internet access. AI-powered tools reconnect and reintegrate upon restoration of connectivity.

User Customization—Each interface tool may be hidden, pinned, or triggered dynamically, providing an adaptable workspace tailored to the user's preferred flow.

The invention offers a comprehensive and intuitive platform to support authors at all experience levels, improving efficiency, organization, and output quality throughout the writing process.

### DESCRIPTION OF EMBODIMENTS WITH REFERENCE TO THE DRAWINGS

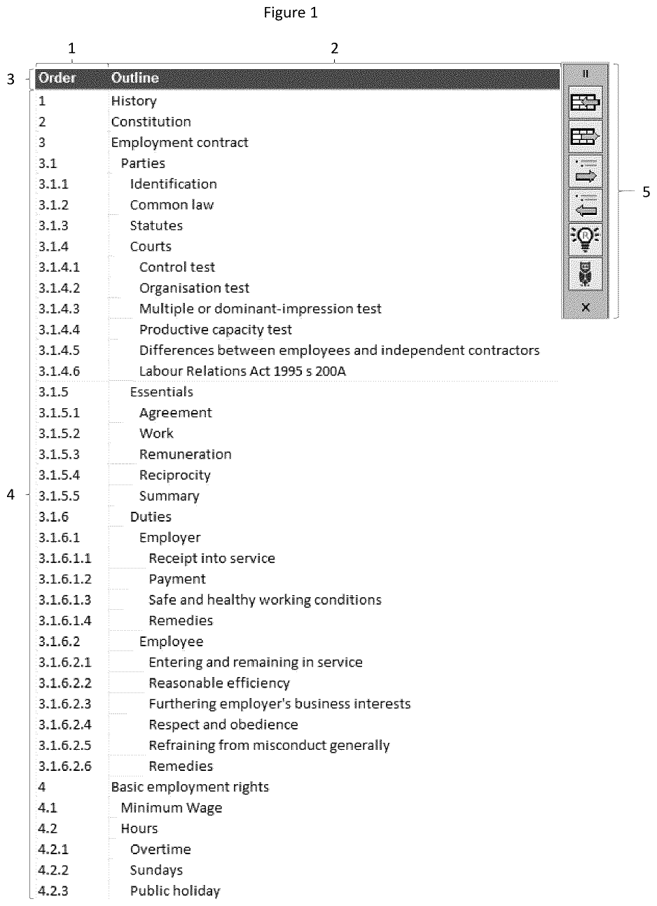

### FIG. 1: “Outline Worksheet”.

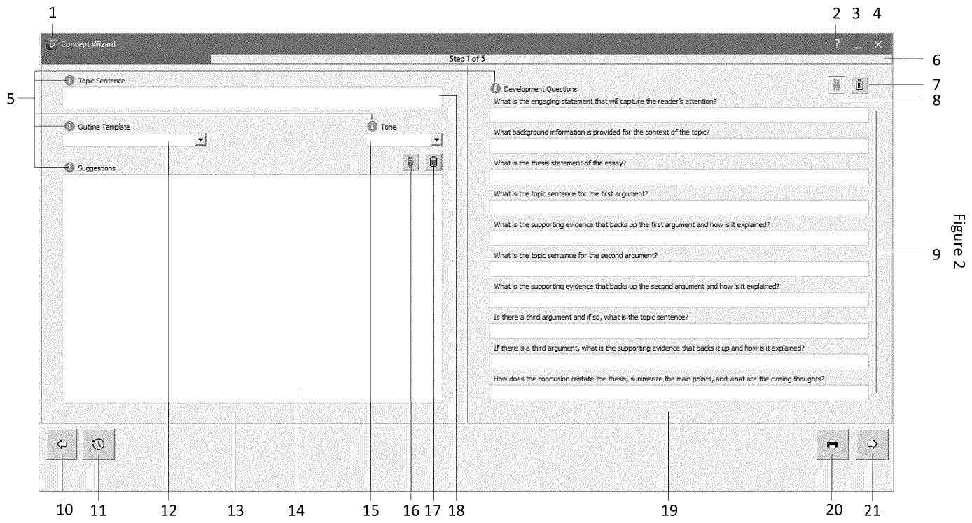

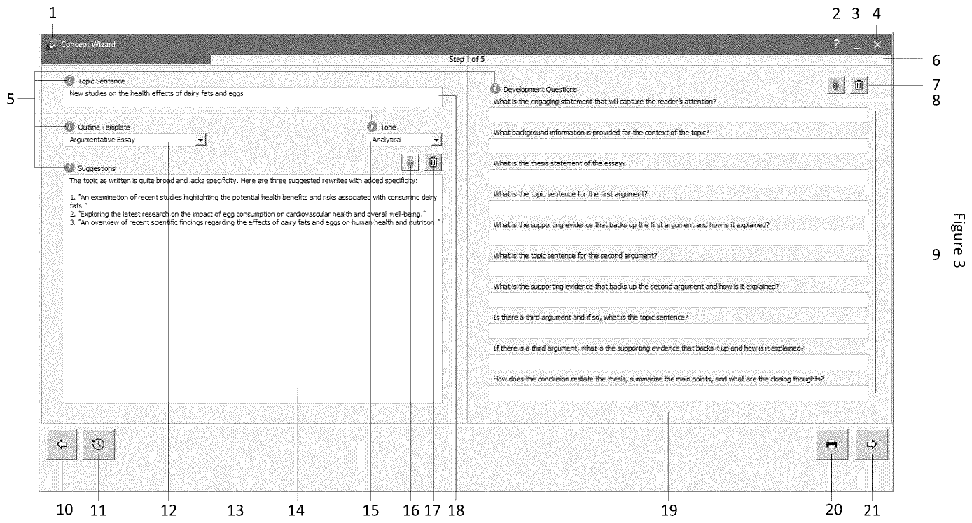

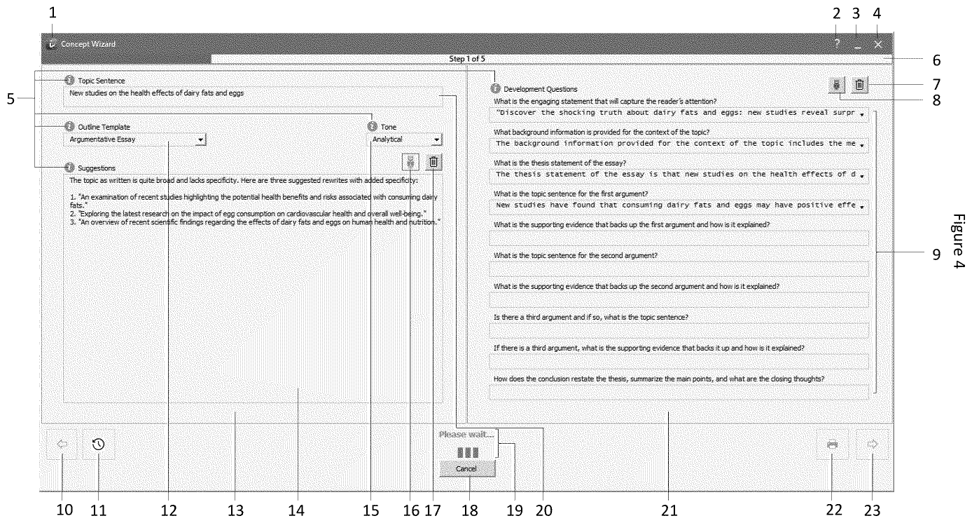

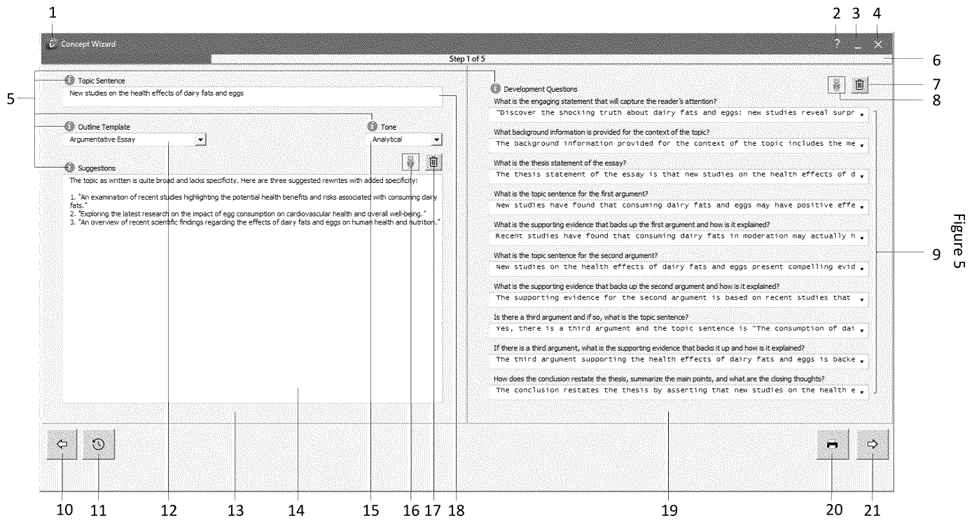

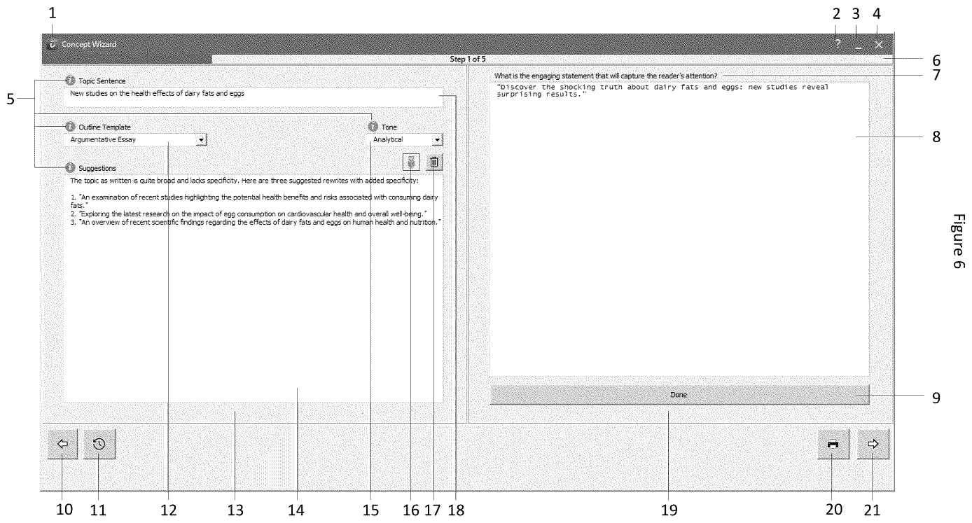

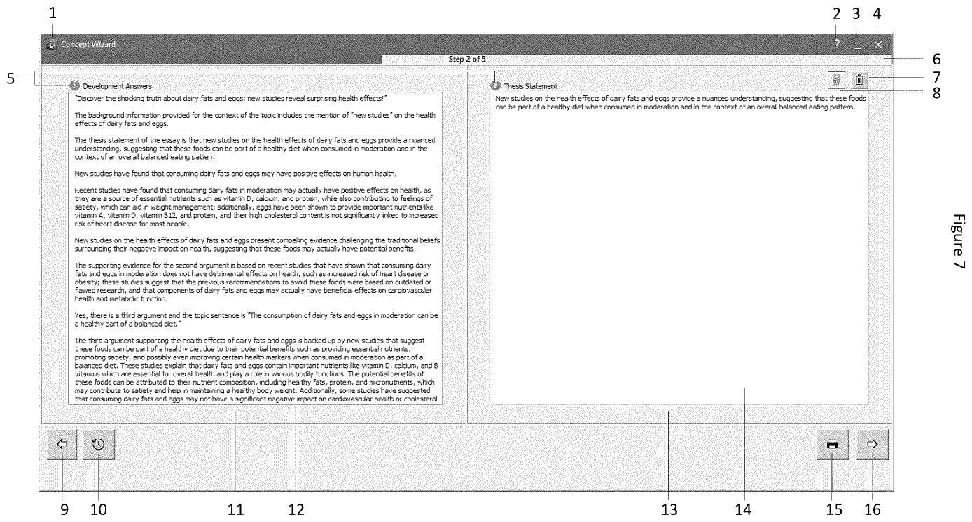

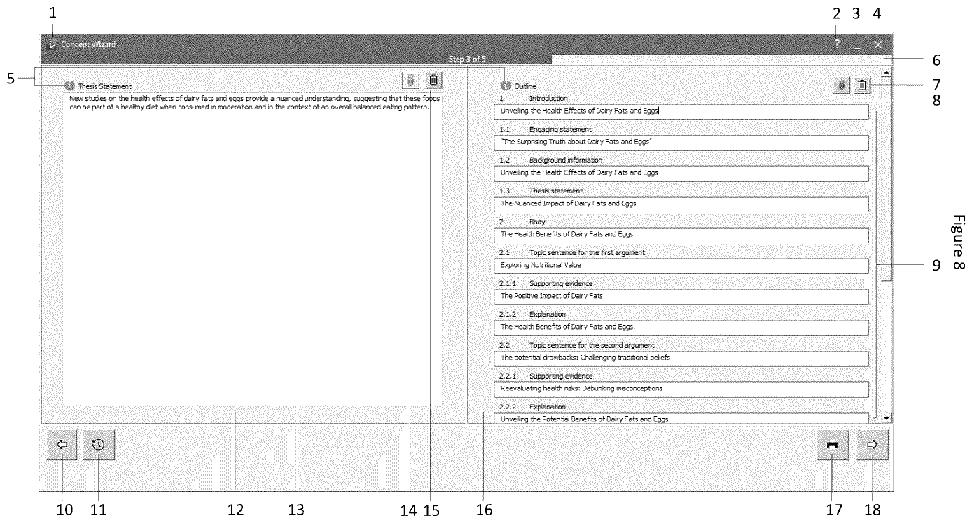

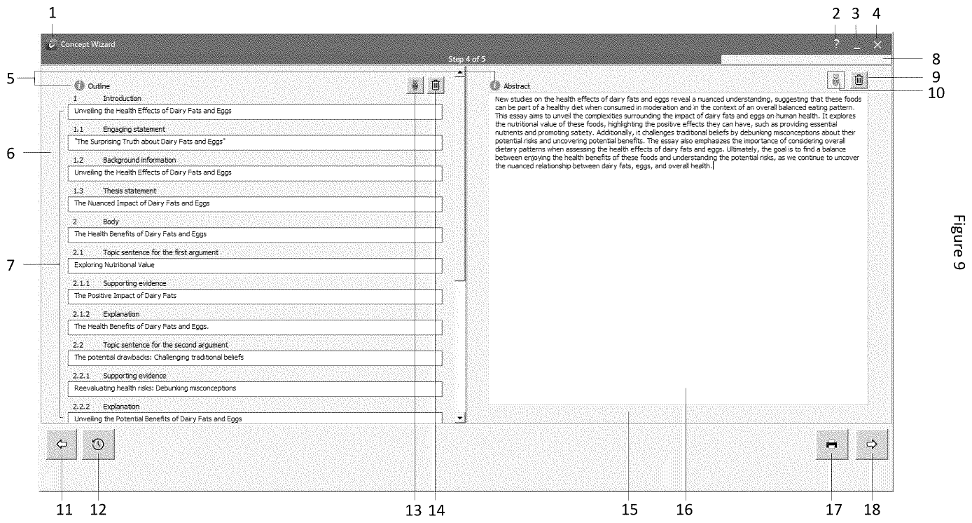

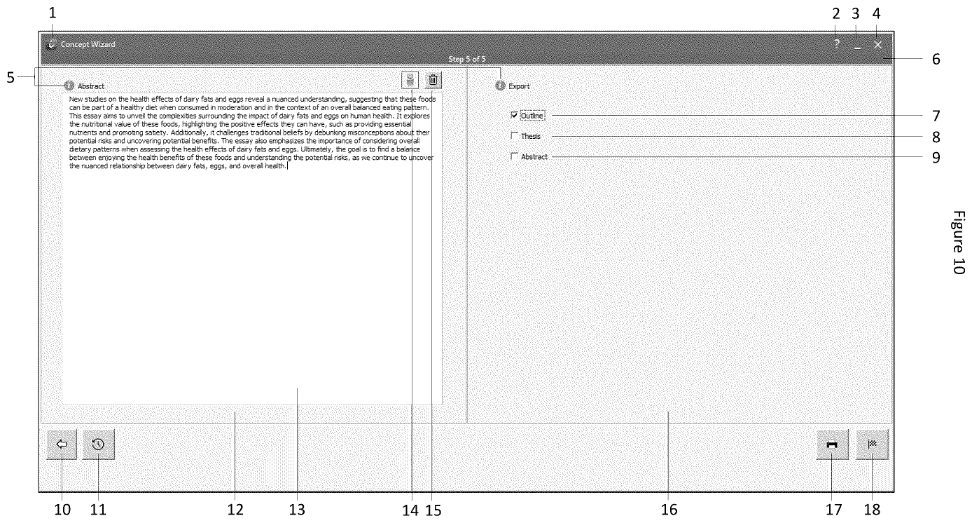

1. Order column: the fields containing decimal numbers that identify and show the organization hierarchy of outline entries. Whenever the author adds or removes one or more outline entries, the invention responds by automatically assigning and updating each decimal number based on its order in the list and whether an entry properly subtends to the entry above it, the exception being the first heading, which can only be “1”. Users cannot directly enter data into the fields of the order column.
2. Outline Entry column: the input fields for outline entries directly put in by the user or by the Concept Wizard.
3. Column headings: headings that identify the contents in each column.
4. Rows for each outline entry and its corresponding identifying decimal number.
5. Toolbar containing functions specific to the working with the Outline Worksheet.
   FIGS. 2, 3, and 5: “Concept Wizard, Step 1 of 5”, view 1, view 2, and view 4, respectively.
1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information buttons: selecting shows a brief description of what a control or group of controls does.
6. Tool progress bar: indicates in which step of the total number of steps the user is working.
7. Development Answers Request button: selecting invokes the artificial intelligence engine to answer the development questions in keeping with the original topic sentence and the Outline Template and Writing Tone options selected.
8. Clear Development Answers button: selecting clears the contents of the Development Answers fields.
9. Development Answers text boxes: the input fields for containing development answers.
10. Previous Step button: selecting causes the tool to return to the previous step.
11. History button: selecting toggles the visibility of the History slider bar tool.
12. Outline Template dropdown: selecting one of the outline template options determines which development questions will be used and what tenor will be reflected in the abstract and thesis when those are generated.
13. Topic frame: the area that contains the topic development controls.
14. Suggestions text box: the input field for AI-requested suggestions.
15. Writing Tone dropdown: selecting one of the writing tone options influences the tenor that will be reflected in the Development Answers and the abstract and thesis when those are generated.
16. Topic Evaluation and Suggestions Request button: selecting causes the artificial intelligence engine to process the inputs and then generate an evaluation of the original topic sentence as well as suggest alternatives to the original topic sentence, in keeping with Outline Template and Writing Tone options selected.
17. Clear Suggestions button: selecting clears the contents of the Suggestions text box.
18. Topic text box: the input field for the topic.
19. Development Questions frame: the work area for the paper's development questions.
20. Print button: selecting prepares a report of the data showing in the current step that can then be printed.
21. Next Step button: selecting causes the tool to advance to the next step.
   FIG. 4:“Concept Wizard, Step 1 of 5”, view 3.
1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information buttons: selecting shows a brief description of what a control or group of controls does.
6. Tool progress bar: indicates in which step of the total number of steps the user is working.
7. Development Answers Request button: selecting invokes the artificial intelligence engine to answer the development questions in keeping with the original topic sentence and the Outline Template and Writing Tone options selected.
8. Clear Development Answers button: selecting clears the contents of the Development Answers fields.
9. Development Answers text boxes: the input fields for containing development answers.
10. Previous Step button: selecting causes the tool to return to the previous step.
11. History button: selecting toggles the visibility of the History slider bar tool.
12. Outline Template dropdown: selecting one of the outline template options determines which development questions will be used and what tenor will be reflected in the abstract and thesis when those are generated.
13. Topic frame: the area that contains the Topic development controls.
14. Suggestions text box: the input field for AI-requested suggestions.
15. Writing Tone dropdown: selecting one of the writing tone options influences the tenor that will be reflected in the Development Answers and the abstract and thesis when those are generated.
16. Topic Evaluation and Suggestions Request button: selecting causes the artificial intelligence engine to process the inputs and then generate an evaluation of the original topic sentence as well as suggest alternatives to the original topic sentence, in keeping with Outline Template and Writing Tone options selected.
17. Clear Suggestions button: selecting clears the contents of the Suggestions text box.
18. Artificial intelligence engine processing indicator: the indicator that shows the processing status of the artificial intelligence engine.
19. Cancel button: selecting cancels the artificial intelligence engine's processing.
20. Topic text box: the input field for the topic.
21. Development Questions frame: the work area for the paper's development questions.
22. Print button: selecting prepares a report of the data showing in the current step to be printed.
23. Next Step button: selecting causes the tool to advance to the next step.
   FIG. 6: “Concept Wizard, Step 1 of 5”, view 5.
1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information buttons: selecting shows a brief description of what a control or group of controls does.
6. Tool progress bar: indicates in which step of the total number of steps the user is working.
7. Development Question label: Repeats one of the questions from the Development Questions group.
8. Development Answer text box: an input field for containing the answer to an individual development question.
9. Done button: selecting closes the Development Answer text box and causes the Development Questions and Answers to reappear.
10. Previous Step button: selecting causes the tool to return to the previous step.
11. History button: selecting toggles the visibility of the History slider bar tool.
12. Outline Template dropdown: selecting one of the outline template options determines which development questions will be used and what tenor will be reflected in the abstract and thesis when those are generated.
13. Topic frame: the area that contains the Topic development controls.
14. Suggestions text box: the input field for AI-requested suggestions.
15. Writing Tone dropdown: selecting one of the writing tone options influences the tenor that will be reflected in the Development Answers and the abstract and thesis when those are generated.
16. Topic Evaluation and Suggestions Request button: selecting causes the artificial intelligence engine to process the inputs and then generate an evaluation of the original topic sentence as well as suggest alternatives to the original topic sentence, in keeping with Outline Template and Writing Tone options selected.
17. Clear Suggestions button: selecting clears the contents of the Suggestions text box.
18. Topic text box: the input field for the topic.
19. Development Questions frame: the work area for the paper's development questions.
20. Print button: selecting prepares a report of the data showing in the current step to be printed.
21. Next Step button: selecting causes the tool to advance to the next step.
   FIG. 7: “concept Wizard, Step 2 of 5.
1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information buttons: selecting shows a brief description of what a control or group of controls does.
6. Tool progress bar: indicates in which step of the total number of steps the user is working.
7. Clear Thesis button: selecting clears the contents of the Thesis text box.
8. Thesis Request button: selecting causes the artificial intelligence engine to process the inputs and then generate a thesis based on the original topic sentence and answers to the Development Questions.
9. Previous Step button: selecting causes the tool to return to the previous step.
10. History button: selecting toggles the visibility of the History slider bar tool.
11. Development Answers frame: the work area for the answers to the paper's Development Questions.
12. Development Answers text box: the input field for the answers to the Development Questions.
13. Thesis frame: the work area for the answers to the Thesis development controls.
14. Thesis text box: the input field for developing the paper's Thesis.
15. Print button: selecting prepares a report of the data showing in the current step to be printed.
16. Next Step button: selecting causes the tool to advance to the next step.
   FIG. 8: “concept Wizard, Step 3 of 5.
1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information buttons: selecting shows a brief description of what a control or group of controls does.
6. Tool progress bar: indicates in which step of the total number of steps the user is working.
7. Clear Outline button: selecting clears the contents of the Outline fields.
8. Outline Request button: selecting causes the artificial intelligence engine to process the inputs and then generate an outline based on the original topic sentence as well as the Outline Template and Writing Tone options selected.
9. Outline text boxes: the input fields for containing outline entries.
10. Previous Step button: selecting causes the tool to return to the previous step.
11. History button: selecting toggles the visibility of the History slider bar tool.
12. Thesis frame: the work area for the answers to the Thesis development controls.
13. Thesis text box: the input field for developing the paper's Thesis.
14. Thesis Request button: selecting causes the artificial intelligence engine to process the inputs and then generate a thesis based on the original topic sentence and answers to the Development Questions.
15. Clear Thesis button: selecting clears the contents of the Thesis text box.
16. Outline frame: the work area for the Outline development controls.
17. Print button: selecting prepares a report of the data showing in the current step to be printed.
18. Next Step button: selecting causes the tool to advance to the next step.
   FIG. 9: “concept Wizard, Step 4 of 5.
1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information buttons: selecting shows a brief description of what a control or group of controls does.
6. Outline frame: the work area for the Outline development controls.
7. Outline text boxes: the input fields for containing outline entries.
8. Tool progress bar: indicates in which step of the total number of steps the user is working.
9. Clear Abstract button: selecting clears the contents of the Abstract text box.
10. Abstract Request button: selecting causes the artificial intelligence engine to process the inputs and then generate an abstract based on the original topic sentence and answers to the Development Questions.
11. Previous Step button: selecting causes the tool to return to the previous step.
12. History button: selecting toggles the visibility of the History slider bar tool.
13. Outline Request button: selecting causes the artificial intelligence engine to process the inputs and then generate an outline based on the original topic sentence as well as the Outline Template and Writing Tone options selected.
14. Clear Outline button: selecting clears the contents of the Outline fields.
15. Abstract frame: the work area for containing the answers to the Abstract development controls.
16. Abstract text box: the input field for developing the paper's Abstract.
17. Print button: selecting prepares a report of the data showing in the current step to be printed.
18. Next Step button: selecting causes the tool to advance to the next step.
   FIG. 10: “concept Wizard, Step 5 of 5.
1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information buttons: selecting shows a brief description of what a control or group of controls does.
6. Tool progress bar: indicates in which step of the total number of steps the user is working.
7. Export Outline checkbox: selecting allows the exporting of the outline created by the Concept Wizard to the Outline worksheet if the user thereafter selects the Finish button.
8. Export Thesis checkbox: selecting allows the exporting of the thesis created by the Concept Wizard to the Outline worksheet if the user thereafter selects the Finish button.
9. Export Abstract checkbox: selecting allows the exporting of the abstract created by the Concept Wizard to the Outline worksheet if the user thereafter selects the Finish button.
10. Previous Step button: selecting causes the tool to return to the previous step.
11. History button: selecting toggles the visibility of the History slider bar tool.
12. Abstract frame: the work area for containing the answers to the Abstract development controls.
13. Abstract text box: the input field for developing the paper's Abstract.
14. Abstract Request button: selecting causes the artificial intelligence engine to process the inputs and then generate an abstract based on the original topic sentence and answers to the Development Questions.
15. Clear abstract button: selecting clears the contents of the Abstract text box.
16. Export frame: the work area for the Export controls.
17. Print button: selecting prepares a report of the data showing in the current step to be printed.
18. Finish button: selecting causes the tool to complete its exporting tasks.

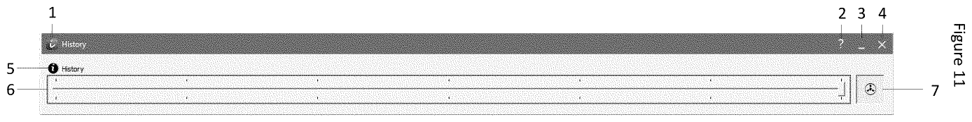

### FIG. 11: “History”.

1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information button: selecting shows a brief description of what a control or group of controls does.
6. History slider bar: selecting lets the user either retrace his steps or revert to any earlier version of the text in the current step.
7. Record History button: selecting enables or disables the recording of edit changes made during the session with the Concept Wizard.

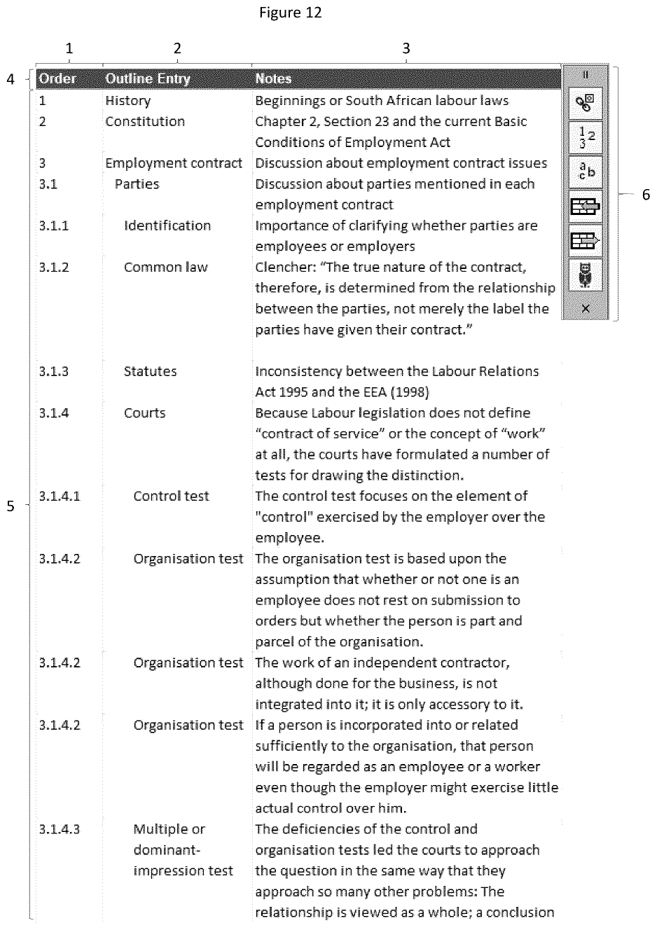

### FIG. 12: “Notes Worksheet”.

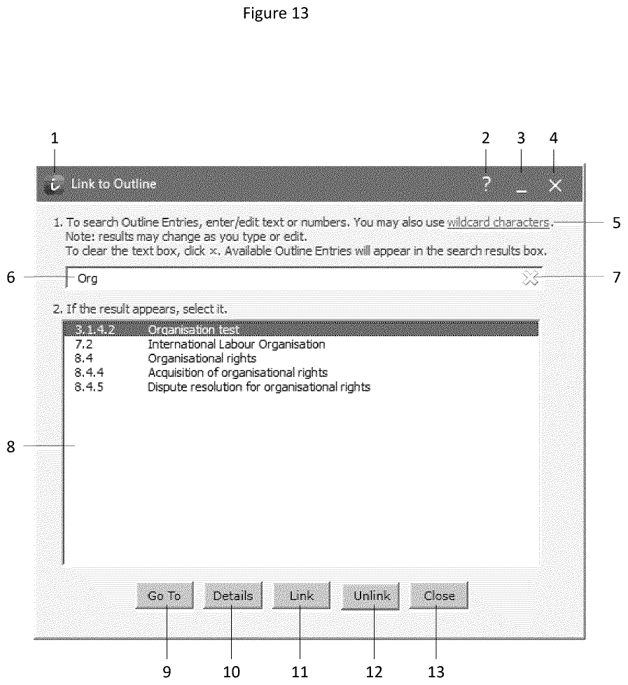

1. Order column: the input fields for displaying decimal numbers that identify and show organization hierarchy of outline entries. The identifier appears once the user has associated an outline entry with a given note. Users cannot directly enter data into its input fields.
2. Outline Entry column: the input fields for displaying each outline entry associated with its unique identifier. Users cannot directly enter data into its input fields.
3. Notes column: the input fields for notes directly put in by the user.
4. Column headings: headings that identify the contents in each column.
5. Rows for each outline entry and its corresponding identifying decimal number, associated with a given note.
6. Toolbar containing functions specific to the working with the contents in the Notes Worksheet.
   FIG. 13: “link to Outline”.
1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Wildcard Character information hyperlink button: selecting shows a guide for adding wildcard characters to a search string to attain the desired results.
6. Search text box: the input field for entering text to narrow the number of outline options returned.
7. Clear Search button: selecting clears the contents of the Search text box.
8. Results list box. selecting a result allows the user to proceed using the Go To, Details, Link, and Unlink functions.
9. Go To button: selecting causes invention to navigate directly to the selected outline entry.
10. Details button: selecting shows the entire contents of the result selected.
11. Link button: selecting associates an outline entry to one or more notes selected.
12. Unlink button: selecting dissociates an outline entry with one or more notes selected.
13. Close button: selecting causes the tool to close. This second close button is included for convenience.

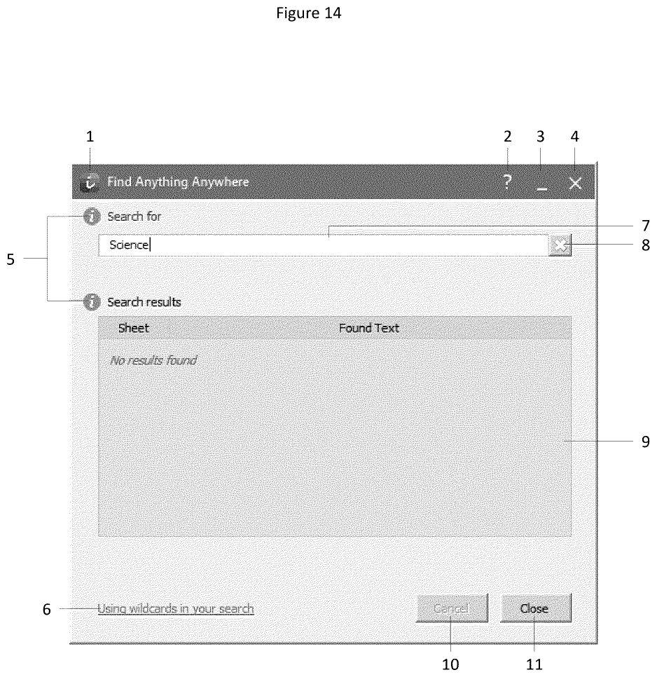

### FIG. 14: “Find Anything Anywhere”.

1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information buttons: selecting shows a brief description of what a control or group of controls does.
6. Show “Wildcard Characters” popup. selecting causes the “Wildcard Characters” popup to appear.
7. Search For text box: the input field for entering text.
8. Clear Search For Text button: selecting clears the contents of the Search For Text text box.
9. Search Results list box: the area for showing search results. selecting a result causes the worksheet and search result to appear.
10. Cancel button: selecting cancels navigation to the search result.
11. Close button: selecting causes the tool to close.

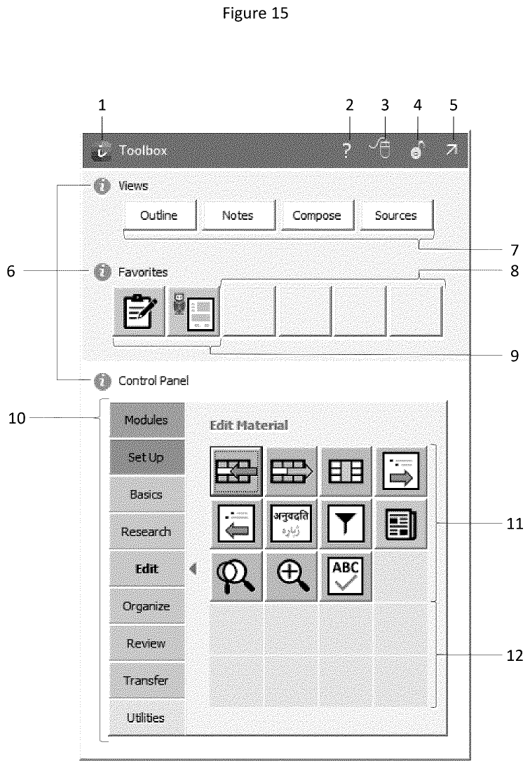

### FIG. 15: “Toolbox”.

This is a primary view of the tool, showing function buttons available to a page indicated in the side tabs.
1. Home Page Link button: selecting opens a browser window with a link to the application's home page.
2. Help button: selecting opens the application's help system to the page describing the purpose of the tool and how to use it.
3. Dynamic or Fixed Size button: selecting cycles through the various views of the toolbox and whether it changes size according to where the mouse cursor hovers over it.
4. Dynamic Visibility button: selecting toggles whether the toolbox is always visible or hides in certain circumstances.
5. Park button: selecting toggles whether the toolbox is parked in a predetermined, out-of-the-way location or stays where the user places it.
6. Information buttons: selecting shows a brief description of what a control or group of controls does.
7. Page Navigation buttons: selecting one causes the related worksheet to show.
8. Favorites placeholders: Each indicates where the user may position a shortcut to a favorite function in the control panel.
9. Favorites buttons: selecting causes the function in the control panel it represents to run.
10. Control Panel Page tabs: selecting one of these causes the panel with the related function buttons to show.
11. Function buttons: selecting causes the function it represents to run.
12. Function placeholders: Each indicates where a function button may go in a future release.

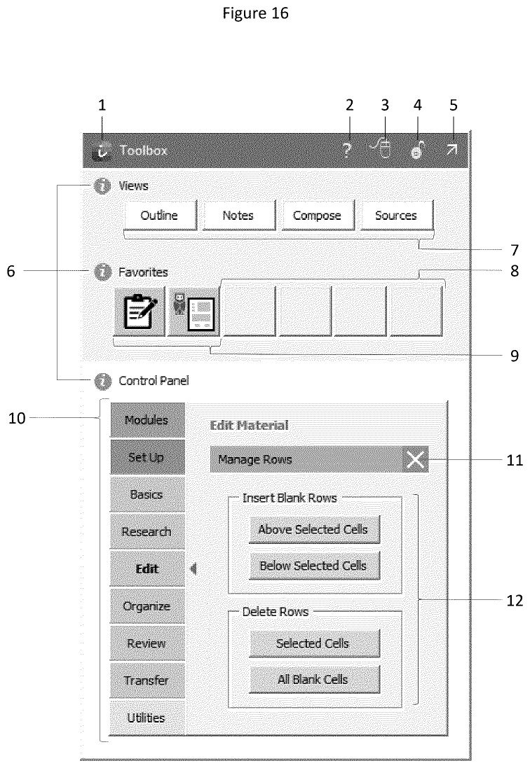

### FIG. 16: “Toolbox”.

This is a secondary view of the tool, showing a submenu when certain function buttons are selected.
1. Home Page Link button: selecting opens a browser window with a link to the application's home page.
2. Help button: selecting opens the application's help system to the page describing the purpose of the tool and how to use it.
3. Dynamic or Fixed Size button: selecting cycles through the various views of the toolbox and whether it changes size according to where the mouse cursor hovers over it.
4. Dynamic Visibility button: selecting toggles whether the toolbox is always visible or hides in certain circumstances.
5. Park button: selecting toggles whether the toolbox is parked in a predetermined, out-of-the-way location or stays where the user places it.
6. Information buttons: selecting shows a brief description of what a control or group of controls does.
7. Page Navigation buttons: selecting one causes the related worksheet to show.
8. Favorites placeholders: Each indicates where the user may position a shortcut to a favorite function in the control panel.
9. Favorites buttons: selecting causes the function in the control panel it represents to run.
10. Control Panel Page tabs: selecting one of these causes the panel with the related function buttons to show.
11. Submenu Close button: selecting causes the submenu to close.
12. Submenu Controls frame: The space for containing submenu controls. Note: contents vary in this view, depending on the function selected.

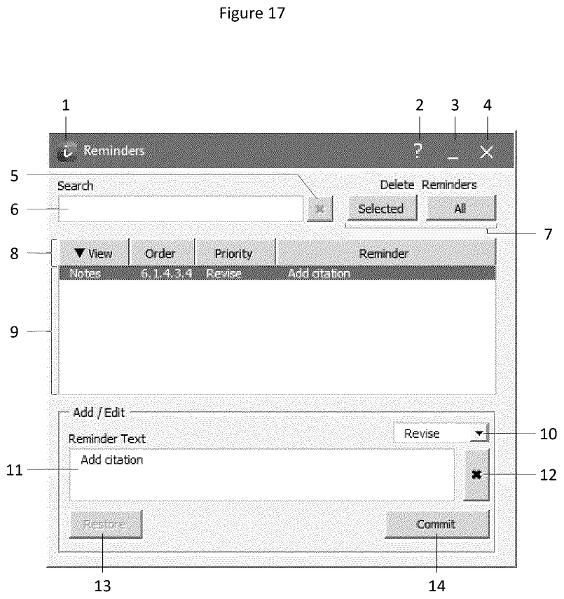

### FIG. 17: “Reminders”.

1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Clear Search button: selecting clears the contents of the Search text box.
6. Search text box: the input field for entering text that appears in at least one reminder to appear in context in the Reminders list box.
7. Delete Reminders buttons: selecting “Selected” causes the reminders selected in the Reminders list box to be deleted both from the list box and on pages where they appear. selecting “All” causes all reminders to be deleted.
8. Column Sort buttons: selecting any of these buttons will cause the list to be sorted using the corresponding key as the sort field. Clicking the same button in succession causes the list to be sorted using the corresponding key, only in the reverse order.
9. Reminders list box: selecting an item in this list causes the page on which the reminder exists to show, and the corresponding reminder to appear as a popup window.
10. Reminder type dropdown: selecting one of the reminder types categorizes the reminder to be created.
11. Reminder Text text box: the input field for entering text that will appear in the reminder to be created.
12. Clear Reminder Text button: selecting clears the contents of the Reminder Text text box.
13. Restore Edited Reminder Text button: selecting restores the contents of the Reminder Text text box.
14. Commit Reminder button: selecting adds the reminder to field selected on one of the four worksheets.

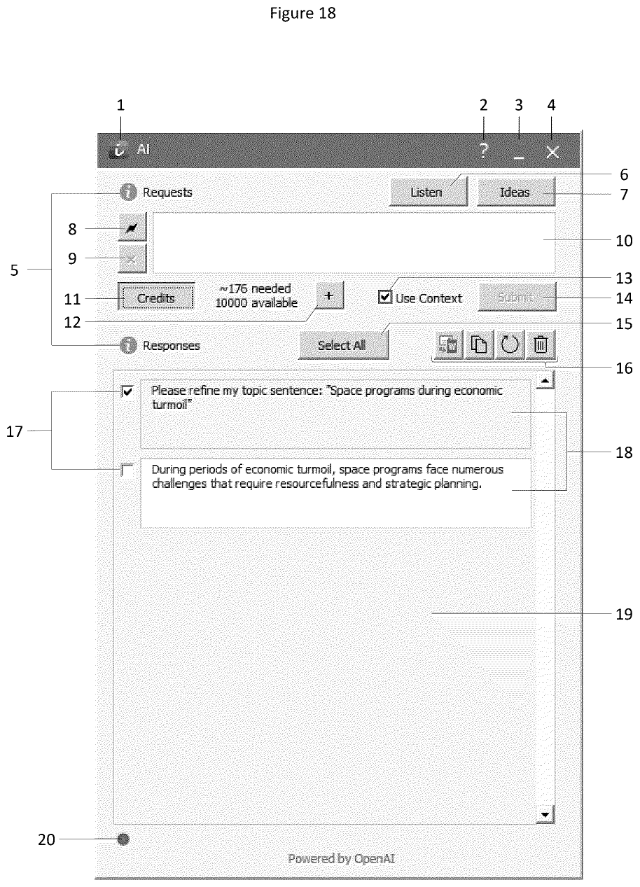

### FIG. 18: “AI”.

1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information buttons: selecting shows a brief description of what a control or group of controls does.
6. Listen button: selecting causes the tool to listen for the keyword and then to begin voice-to-text transcription into the Requests text box.
7. Ideas button: selecting causes the Ideas list box containing AI-requested suggestions to appear.
8. Quick Start button: selecting causes the tool to suggest the next step or steps to take.
9. Clear Requests button: selecting clears the contents of the Requests text box.
10. Requests text box: the input field for entering text for the artificial intelligence engine to process.
11. Credits button: selecting toggles a report showing how many credits are needed to respond, how many are available, and the Add Credits button.
12. Add credits button: selecting causes the add credits tool to appear.
13. Use Context checkbox: Checking causes the artificial intelligence engine to consider the context of its previous responses in its upcoming response.
14. Submit button: selecting causes the request to be sent to the artificial intelligence engine.
15. Select All button (checkbox): selecting causes all Include Response checkboxes to be checked.
16. Manage Responses buttons: Provide the following services for all responses selected: create a Word file using the texts; copy the texts to the clipboard; restore edited response texts; delete text.
17. Include Response checkbox: selecting enables each Manage Responses function to process the contents of the Response text box.
18. Response text box: the input field for the artificial intelligence engine to place its response. The user may also edit this field.
19. Responses list box: the area for showing responses from the artificial intelligence engine.
20. Listening Status indicator: the indicator that shows the listening status of the artificial intelligence engine. Explanatory texts may appear beside it.

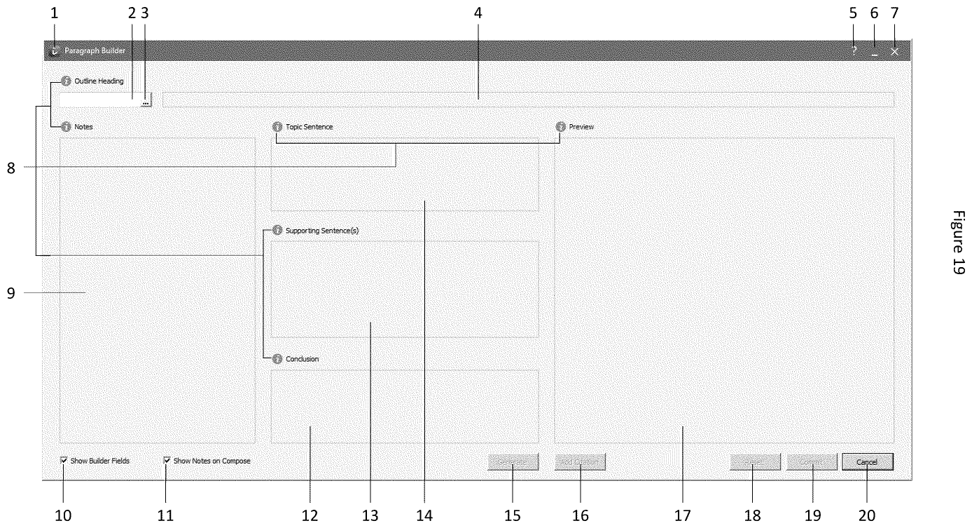

### FIG. 19: “Paragraph Builder”.

1. Home Page Link button: selecting opens a browser window with a link to the application's home page.
2. Outline Heading Decimal Number text box: the input field for entering an outline heading decimal number to retrieve the outline heading entry and any notes associated with it.
3. Outline Heading Number expansion button: selecting causes the complete list of Outline Heading Decimal Numbers to show.
4. Outline Heading Text text box: the field that shows the heading text.
5. Help button: selecting opens the application's help system to the page describing the purpose of the tool and how to use it.
6. Minimize button: selecting causes the tool to toggle between a minimized and full view.
7. Close button: selecting causes the tool to close.
8. Information buttons: selecting shows a brief description of what a control or group of controls does.
9. Notes text box: the field that shows notes associated with the selected heading.
10. Show Builder Fields text box: When enabled, auxiliary Builder fields are shown in the Paragraph Builder.
11. Show Notes on Compose text box: When enabled, the Notes column shows on the Compose worksheet.
12. Conclusion & Transition text box: Input box for entering and editing the concluding and transitional sentence or sentences.
13. Supporting Sentence(s) text box: Input box for entering and editing the supporting sentence or sentences.
14. Topic Sentence text box: Input box for entering and editing the topic sentence.
15. Generate button: selecting causes the tool to concatenate the contents of the Topic Sentence, Supporting Sentence(s), and Conclusion & Transition text boxes to appear as a single paragraph in the Preview text box.
16. Add Citation button: selecting causes the Add/Remove Citation tool to appear.
17. Preview text box: the input field entering and editing paragraphs.
18. Reset button: selecting causes the original content (if any) in the Preview text box to be restored.
19. Commit button: selecting causes the newer content to overwrite the existing content.
20. Cancel button: selecting causes the tool to close.

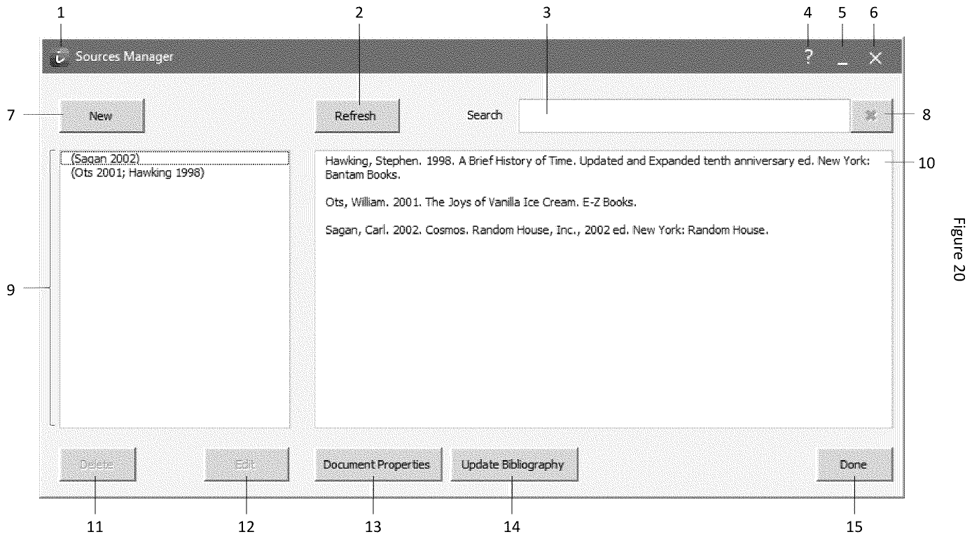

### FIG. 20: “Sources Manager”.

1. Home Page Link button: selecting opens a browser window with a link to the application's home page.
2. Refresh button: selecting updates the list of References text box.
3. Search text box: the input field for entering text that appears in at least one citation to appear in context in the References text box.
4. Help button: selecting opens the application's help system to the page describing the purpose of the tool and how to use it.
5. Minimize button: selecting causes the tool to toggle between a minimized and full view.
6. Close button: selecting causes the tool to close.
7. New button: selecting causes the Zotero Citation Search bar to appear.
8. Clear Search button: selecting clears the contents of the Search text box.
9. Citations list box: the area for selecting an available citation.
10. References text box: the text field showing all the references to be included in the citations.
11. Delete button: When a citation is selected from the Citation list box, selecting Delete causes the citation to be removed.
12. Edit button: When a citation is selected from the Citation list box, selecting Edit causes the Zotero Citation Search bar to appear.
13. Document Properties button: selecting causes the Zotero Document Preferences dialog box to appear.
14. Update Bibliography button: selecting causes the Zotero Edit Bibliography dialog box to appear.
15. Done button: selecting causes the tool to close.

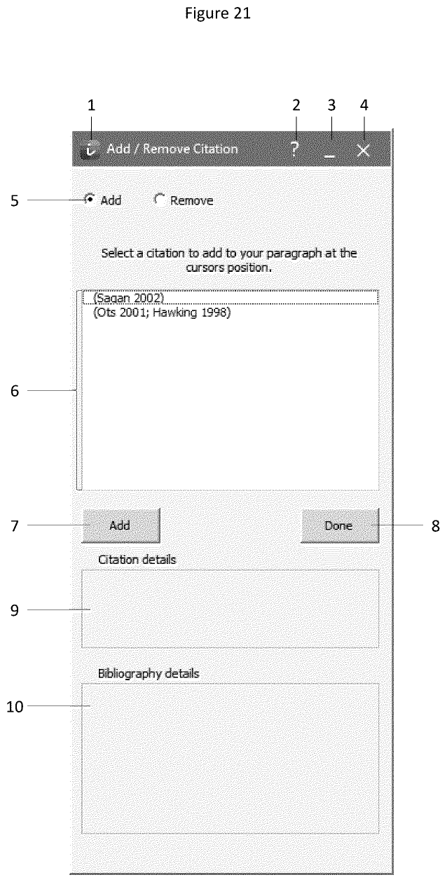

### FIG. 21: “Add/Remove Citation”.

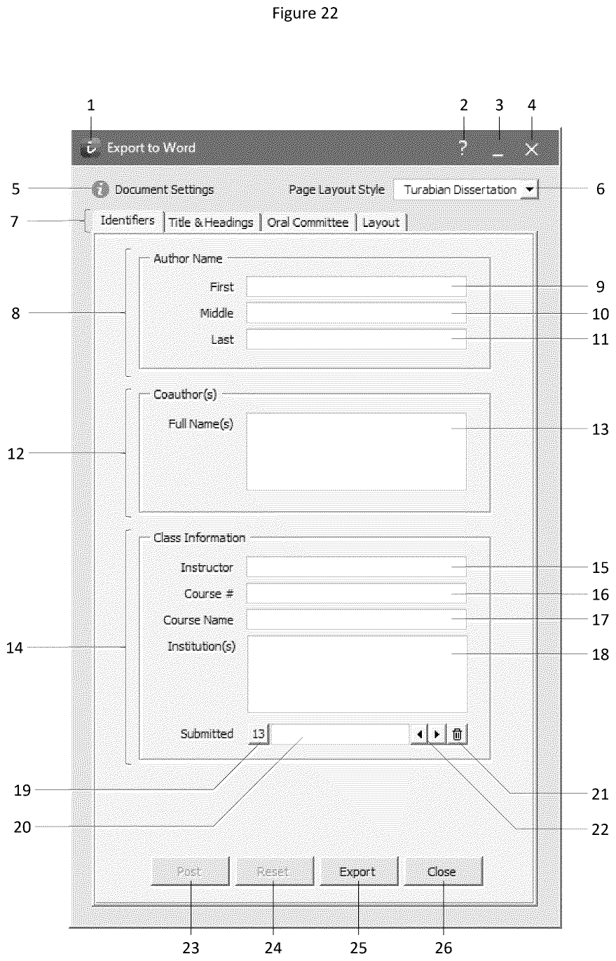

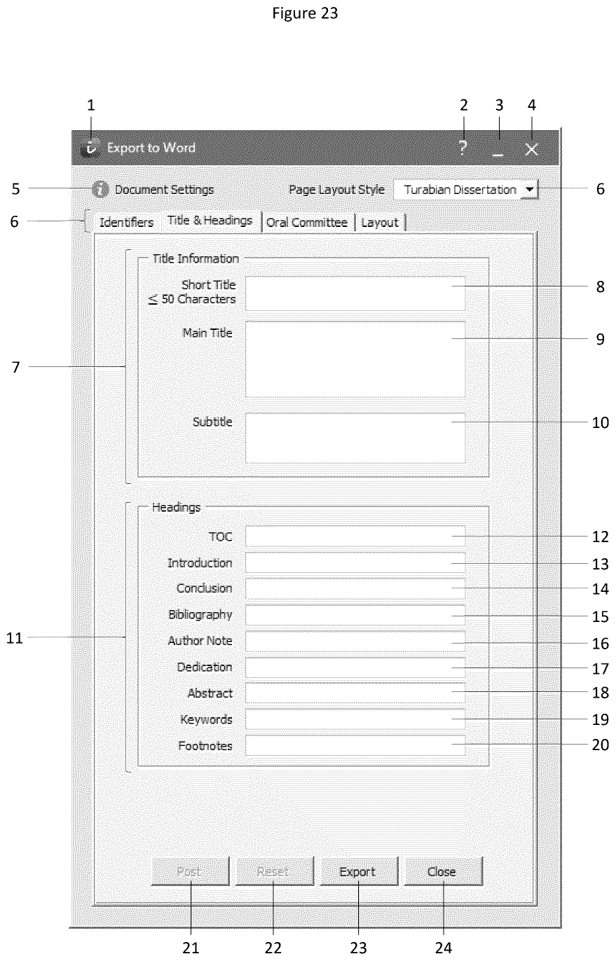

1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Add/Remove option buttons: selecting the Add option allows the tool to add the citation selected in the Citations list box to the paragraph; selecting the Remove option allows the tool to remove all instances of the citation selected in the Citations list box from the paragraph.
6. Citations list box: the area for selecting an available citation.
7. Add button: When a citation is selected from the Citation list box, selecting Add causes the tool to add that citation to text in the Preview text box. If the cursor is positioned in a location in the Preview text box other than at the end, the Citation will be placed there.
8. Done button: selecting causes the tool to close.
9. Citation details text box: An area to show more information about the selected citation.
10. Bibliography details text box: An area to show more information about the references in the selected citation.
   FIG. 22: “Export to Word”, Identifiers view.
1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information button: selecting shows a brief description of what a control or group of controls does.
6. Page Layout Style dropdown: selecting one of the Page Layout Style options determines which standard academic paper format will be followed when the data are exported.
7. Document Settings tabs: selecting one of the document settings tabs will show the groups of controls pertaining to the aspect of the paper described on the tab.
8. Author Name frame: the area that contains the Author Name controls.
9. First Name text box: the input field for the author's first name.
10. Middle Name text box: the input field for the author's middle name.
11. Last Name text box: the input field for the author's last name.
12. Coauthor(s) frame: the area that contains the Coauthors Names control.
13. Full Name(s) text box: the input field for all coauthors'full names.
14. Class Information frame: the area that contains the class information controls.
15. Instructor text box: the input field for the instructor's full name.
16. Course ID text box: the input field for the course identification code.
17. Course Name text box: the input field for the course name.
18. Institution(s) text box: the input field for the name of the institution.
19. Enter Today's Date button: selecting cause the current date to appear in the Date Submitted text box.
20. Date Submitted text box: the input field for the date the paper is submitted.
21. Increment/Decrement Date spin button: selecting increments or decrements the date in the Date Submitted text box.
22. Clear Date button: selecting clears the contents of the Date Submitted text box.
23. Post button: selecting causes any updated field or setting in the current view to be saved to its storage area.
24. Reset button: selecting causes all updated fields and settings to be reset to their previous values.
25. Export button: creates a Word document based on the Page Layout Style value and using every field with data.
26. Close button: selecting causes the tool to close.
   FIG. 23: “Export to Word”, Titles & Headings view.
1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information button: selecting shows a brief description of what a control or group of controls does.
6. Page Layout Style dropdown: selecting one of the Page Layout Style options determines which standard academic paper format will be followed when the data are exported.
7. Document Settings tabs: selecting one of the document settings tabs will show the groups of controls pertaining to the aspect of the paper described on the tab.
8. Title Information frame: the area that contains the title information controls.
9. Short Title text box: the input field for the paper's short title.
10. Main Title text box: the input field for the paper's main title.
11. Subtitle text box: the input field for the paper's subtitle.
12. Headings frame: the area that contains the heading controls.
13. Table of Contents text box: the input field for the table of contents'heading.
14. Introduction text box: the input field for the introduction's heading.
15. Conclusion text box: the input field for the conclusion's heading.
16. Bibliography text box: the input field for the bibliography's heading.
17. Author Note text box: the input field for the author note's heading.
18. Abstract text box: the input field for the abstract's heading.
19. Keywords text box: the input field for the keywords'heading.
20. Footnotes text box: the input field for the footnotes'heading.
21. Post button: selecting causes any updated field or setting in the current view to be saved to its storage area.
22. Reset button: selecting causes all updated fields and settings to be reset to their previous values.
23. Export button: creates a Word document based on the Page Layout Style value and using every field with data.
24. Close button: selecting causes the tool to close.

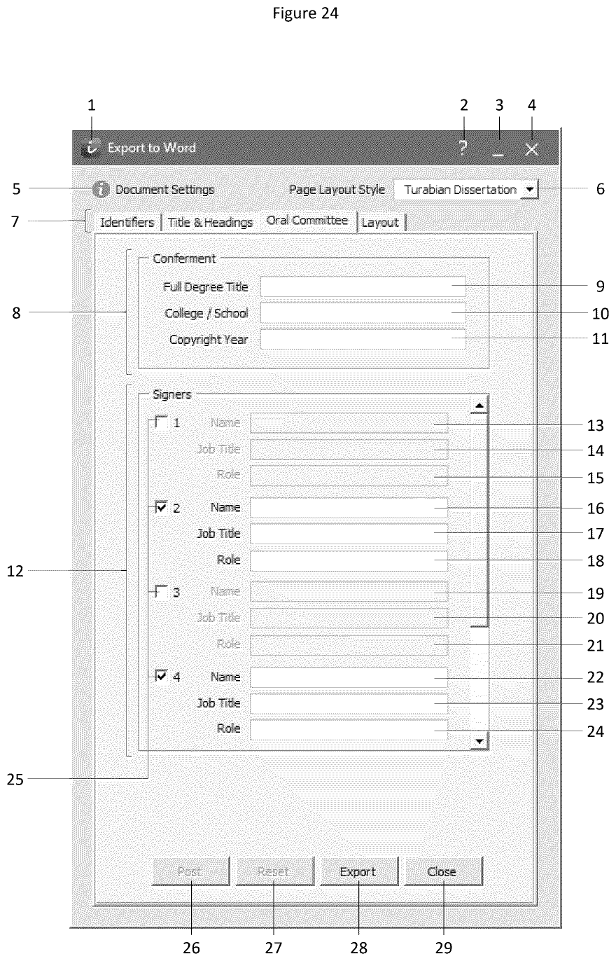

### FIG. 24: “Export to Word”, Oral Committee View.

1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information button: selecting shows a brief description of what a control or group of controls does.
6. Page Layout Style dropdown: selecting one of the Page Layout Style options determines which standard academic paper format will be followed when the data are exported.
7. Document Settings tabs: selecting one of the document settings tabs will show the groups of controls pertaining to the aspect of the paper described on the tab.
8. Conferment frame: the area that contains the degree conferment controls.
9. Department, School, or College text box: the input field for the name of the division of the institution conferring the degree.
10. Degree text box: the input field for the name of the degree.
11. Copyright Year text box: the input field for the year the paper is copyrighted.
12. Signers frame: the area that contains the signers'controls.
13. Signer 1 Name text box: the input field for Signer 1's full name.
14. Signer 1 Job Title text box: the input field for Signer 1's job title.
15. Signer 1 Role text box: the input field for Signer 1's role in the completion of the paper.
16. Signer 2 Name text box: the input field for Signer 2's full name.
17. Signer 2 Job Title text box: the input field for Signer 2's job title.
18. Signer 2 Role text box: the input field for Signer 2's role in the completion of the paper.
19. Signer 3 Name text box: the input field for Signer 3's full name.
20. Signer 3 Job Title text box: the input field for Signer 3's job title.
21. Signer 3 Role text box: the input field for Signer 3's role in the completion of the paper.
22. Signer 4 Name text box: the input field for Signer 4's full name.
23. Signer 4 Job Title text box: the input field for Signer 4's job title.
24. Signer 4 Role text box: the input field for Signer 4's role in the completion of the paper.
25. Include Signer (number) checkbox: selecting the box to the left of the number causes that particular signer's information to be included on the signature page.
26. Post button: selecting causes any updated field or setting in the current view to be saved to its storage area.
27. Reset button: selecting causes all updated fields and settings to be reset to their previous values.
28. Export button: creates a Word document based on the Page Layout Style value and using every field with data.
29. Close button: selecting causes the tool to close.

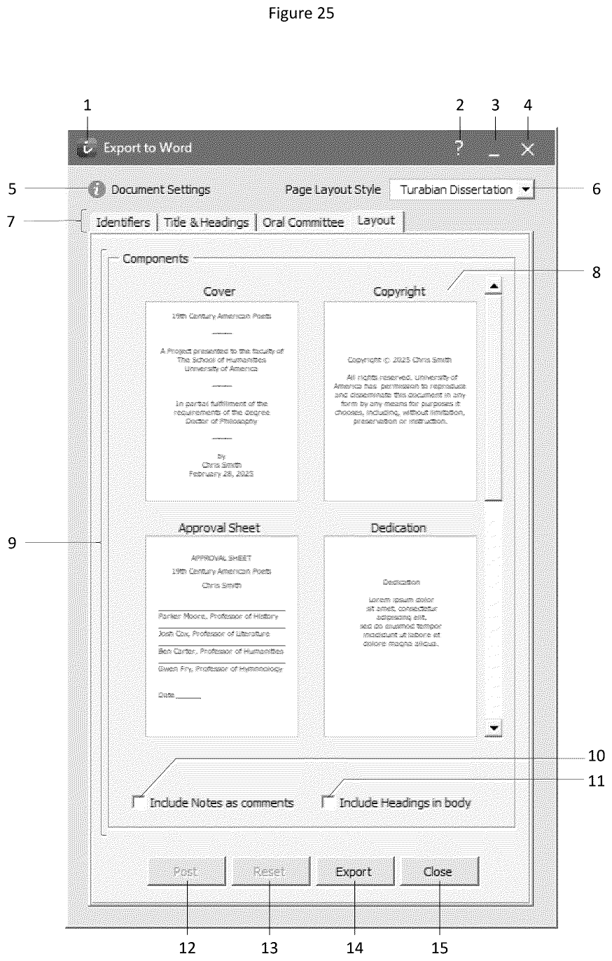

### FIG. 25: “Export to Word”, Layout View.

1. Home Page Link button: selecting opens a browser window with a link to the application's home page.
2. Help button: selecting opens the application's help system to the page describing the purpose of the tool and how to use it.
3. Minimize button: selecting causes the tool to toggle between a minimized and full view.
4. Close button: selecting causes the tool to close.
5. Information button: selecting shows a brief description of what a control or group of controls does.
6. Page Layout Style dropdown: selecting one of the Page Layout Style options determines which standard academic paper format will be followed when the data are exported. When the Layout tab is selected, changing the option in the Page Layout Style dropdown causes the mockup reflecting the particular page layout style to show.
7. Document Settings tabs: selecting one of the document settings tabs changes the view to show controls pertaining to the aspect of the paper described on the tab.
8. Components frame: the area that contains the components controls.
9. Page Layout mockup: a page in the frame that uses representative printed page thumbnails to show a mockup of a paper based on the currently selected layout style.
10. Include Notes as comments checkbox: selecting toggles whether the author's notes will appear as comments in the Word document, associated with the outline heading or subheading in the Notes worksheet.
11. Include Headings in body checkbox: selecting toggles whether the outline headings and subheadings will appear in the text of the Word document.
12. Post button: selecting causes any updated field or setting in the current view to be saved to its storage area.
13. Reset button: selecting causes all updated fields and settings to be reset to their previous values.
14. Export button: creates a Word document based on the Page Layout Style value and using every field containing data.
15. Close button: selecting causes the tool to close.

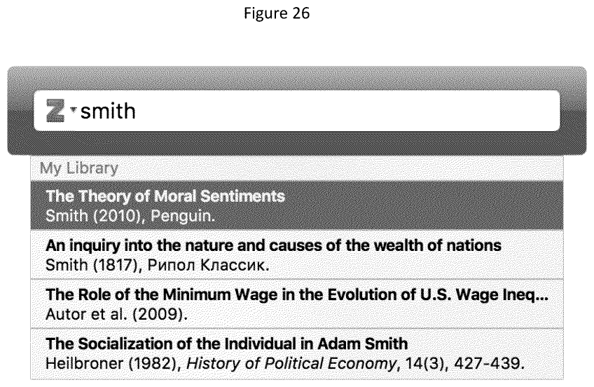

### FIG. 26: “Zotero Citation Search Bar”.

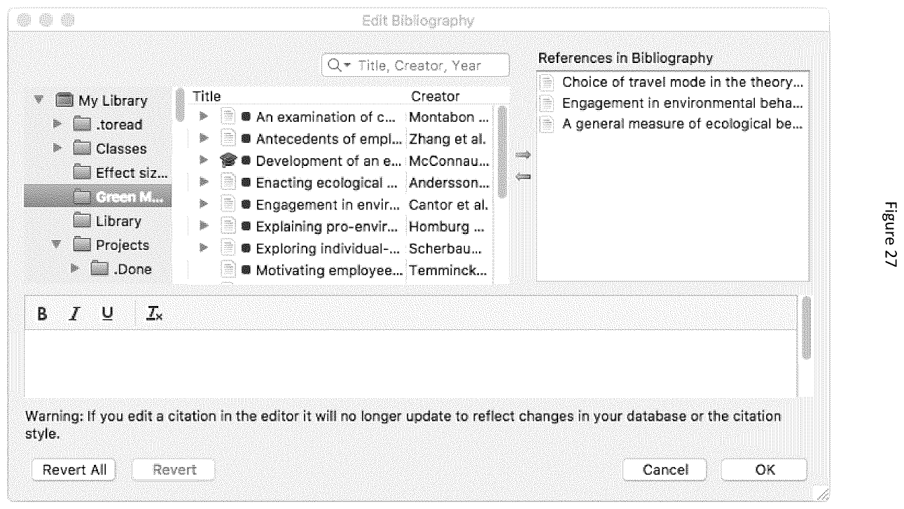

Although not part of the invention, since the description of FIG. 20:
“Sources Manager” refers to this control, it is included for completeness. Information can be found at:
https://www.zotero.org/support/word_processor_plugin_usage
   FIG. 27: “zotero Document Preferences Window”.
Although not part of the invention, since the description of FIG. 20: “Sources Manager” refers to this control, it is included for completeness. Information can be found at:
https:/www.zotero.org/support/ word_processor_plugin_usage#document_preferences

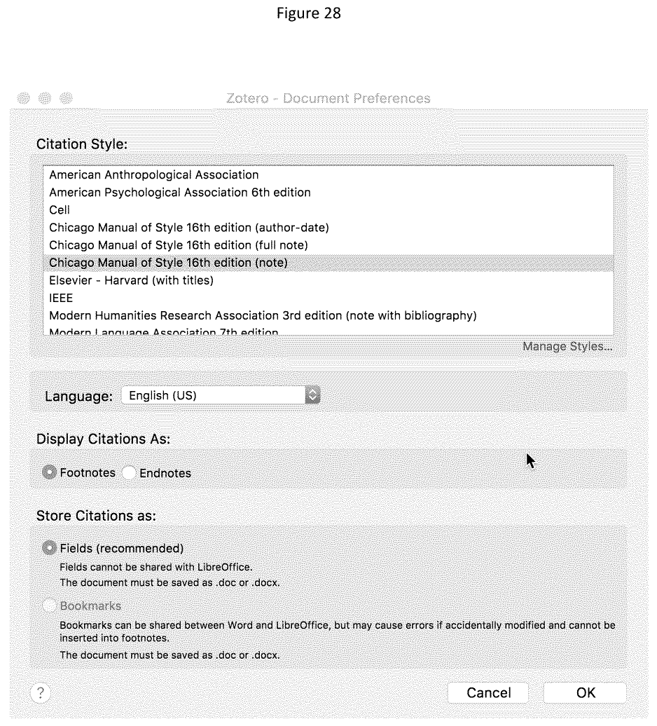

### FIG. 28: “Edit Bibliography Window”.

Although not part of the invention, since the description of FIG. 20: “Sources Manager” refers to this control, it is included for completeness. Information can be found at:
https:/www.zotero.org/support/ word_processor_plugin_usage#editing_the_bibliography

1. An authoring system comprising: a computer-implemented interface configured to assist a user in authoring structured academic or professional papers, the interface comprising: (a) a concept development module configured to guide a user through the creation of foundational paper elements including a topic statement, thesis, abstract, and outline, based on user input and optionally curated suggestions from an artificial intelligence engine; (b) a multi-column grid interface comprising: (i) an outline worksheet for entering and managing hierarchical headings and subheadings; (ii) a notes worksheet for collecting research notes and associating each note with a corresponding outline entry; (iii) a composition area for developing text aligned with the structured outline and associated notes; (c) a citation management module integrated with an external citation tool to insert, manage, and format bibliographic citations; (d) a paragraph builder module configured to generate structured paragraphs from user-supplied or AI-augmented content associated with outline headings; (e) a dynamic export module configured to produce a word processing document at any stage of completion, formatted according to selected academic style guidelines; and (f) a reminder and version history tool enabling users to annotate, revisit, and restore earlier edits or content versions.

2. The system of claim 1, wherein the concept development module includes a multi-step wizard that adapts its workflow and AI-generated suggestions based on the user-specified paper type and desired tone.

3. The system of claim 1, wherein the multi-column grid interface allows simultaneous visibility of outline structure, associated notes, and composition content.

4. The system of claim 1, wherein the outline worksheet includes automatic recalculation and updating of decimal identifiers upon reordering, demotion, or promotion of headings.

5. The system of claim 1, wherein the AI engine provides critique and variation suggestions for the topic statement, and assists in narrowing or broadening the scope based on user feedback.

6. The system of claim 1, wherein user interface components are dynamically shown, minimized, or hidden based on cursor interaction or user preference.

7. The system of claim 1, wherein the export module enables toggling the inclusion of outline headings, author notes, and citation formatting in the generated word processing document.

8. The system of claim 1, wherein the interface and tools are configured to function with or without an active Internet connection, and automatically reintegrate AI-dependent features once online connectivity is restored.

9. A computer-implemented method for assisting an author in creating an academic or professional paper, the method comprising: receiving a user input specifying a paper topic, paper type, and desired tone; generating, using an artificial intelligence engine, one or more topic suggestions and critique feedback; guiding the user through the creation of foundational paper components including a thesis, abstract, and outline via a multi-step wizard; displaying a grid-based interface comprising: (a) a first column for outline entries organized hierarchically by automatically generated decimal identifiers; (b) a second column for associating user-generated notes with specific outline entries; (c) a third column for composing paragraphs related to each outline entry and associated notes; enabling paragraph construction using a paragraph builder tool that composes a paragraph from user-selected topic sentence, supporting sentences, and conclusion; enabling bibliographic citation insertion, editing, and formatting via a citation manager module; exporting the paper, at any stage of development, to a formatted word processing document based on a selected academic formatting style; and enabling at least partial functionality without an Internet connection and restoring full functionality when the connection is re-established.

10. The method of claim 9, wherein outline entries are automatically re-ordered and renumbered in response to user actions including addition, deletion, promotion, or demotion of headings.

11. The method of claim 9, further comprising toggling display of interface components based on cursor activity or user selection, wherein tools may be minimized, hidden, or fixed in position.

12. The method of claim 9, wherein notes are timestamped and sortable, and linked to a specific outline entry.

13. The method of claim 9, further comprising enabling the user to set reminders throughout the paper and display a summary of reminders in a centralized interface.

14. The method of claim 9, further comprising restoring earlier versions of content via a version history interface.

15. A non-transitory computer-readable medium storing instructions that, when executed by one or more processors, cause a computing system to: receive input specifying a paper topic, paper type, and tone from a user; display a multi-step interface guiding the user through concept development, including generation of a thesis, abstract, and outline using an artificial intelligence engine; present a multi-column grid comprising: (a) a first column for outline headings and subheadings organized by hierarchical decimal numbering; (b) a second column for associating user-entered notes with outline headings; (c) a third column for composing paragraph content linked to the notes and headings; invoke a paragraph builder tool for generating structured paragraphs from user-selected or AI-assisted text elements; enable insertion, editing, and formatting of bibliographic citations via a citation manager module; provide export functionality for generating a formatted document in a selected academic style; display and manage reminders throughout the document; store and retrieve version histories of content; and operate with partial functionality offline and restore AI-enhanced capabilities upon reconnecting to the Internet.
